(19) United States
(12) Patent Application Publication
(10) Pub. No.: US 2016/0314513 A1
(43) Pub. Date: Oct. 27, 2016

(54) AUTOMATIC NEGOTIATION USING REAL TIME MESSAGING

(71) Applicant: eBay Inc., San Jose, CA (US)

(72) Inventors: Lakshmanan Velusamy, Bellevue, WA (US); Prithivi Tamilarasan, Bellevue, WA (US); Sadhana Narasimhamurthy, Bellevue, WA (US)

(21) Appl. No.: 14/695,177

(22) Filed: Apr. 24, 2015

(51) Int. Cl. G06Q 30/06; H04L 29/08; H04L 12/58

(52) U.S. Cl. CPC G06Q 30/0629; G06Q 30/0633; G06Q 30/0641; H04L 51/046; H04L 67/02

(57) ABSTRACT

In various example embodiments, a system and method for generating a message that identifies an item listing are presented. A message that identifies a first item listing is received from a client device. A determination of a price of a first item from the first item listing is identified. A second item listing of a second item is identified, the second item being priced lower than the price of the first item. A message that identifies the second item listing is generated. Display of a message that identifies the second item is caused.

### TECHNICAL FIELD

Embodiments of the present disclosure relate generally to data processing and, more particularly, but not by way of limitation, to generating a message that identifies an item listing.

### BACKGROUND

Conventionally, a user may browse an online website in order to search for item listings of items that are listed for a price within the user's price range.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating components of a price system, according to some example embodiments.

FIGS. 3-6 are flowcharts illustrating operations of the price system in performing a method of generating a message that identifies a second item listing, according to some example embodiments.

FIGS. 7-8 are example user interfaces that depict a conversation between a user and the pricing system, according to some example embodiments.

FIG. 9 is an example user interface that depicts an item listing creation page, according to some example embodiments.

FIG. 10 is an example user interface that depicts a message that requests a seller to lower a price of an item, according to some example embodiments.

FIG. 11 is a block diagram illustrating an example of a software architecture that may be installed on a machine, according to some example embodiments.

FIG. 12 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

A user may discover an item available for sale from an online marketplace. However, before a making a final decision about purchasing the item, the user may wish to perform some price comparisons, and see if there are any better deals out there for the same or similar item. Often times, this takes a lot of effort on behalf of the user to manually search for other items from either the same online marketplace or another online marketplace. Therefore, in various example embodiments, methods and systems described herein allow for a user to conveniently find another similar item for a cheaper price. To accomplish this, the system enables the user to send a message that identifies the item. The message may be sent over a messaging platform or service that includes SMS, Twitter®, Facebook®, WhatsApp®, e-mail, and the like. Next, the system will identify another item that is priced lower than the one the user identified. Then, the system will send a message back to the user, the message identifying another item that is available for a cheaper price. In doing so, the system may check a shipping price, sales tax, an amount of rewards credited, and other such pricing points. Also, the system is able to communicate with the user through a variety of ways, including a messaging service that is convenient for the user.

Accordingly, one or more of the methodologies discussed herein may obviate a need for the user to manually search the online marketplace for comparable items, which may have the technical effect of reducing computing resources used by one or more devices within the system. Examples of such computing resources include, without limitation, processor cycles, network traffic, memory usage, storage space, and power consumption.

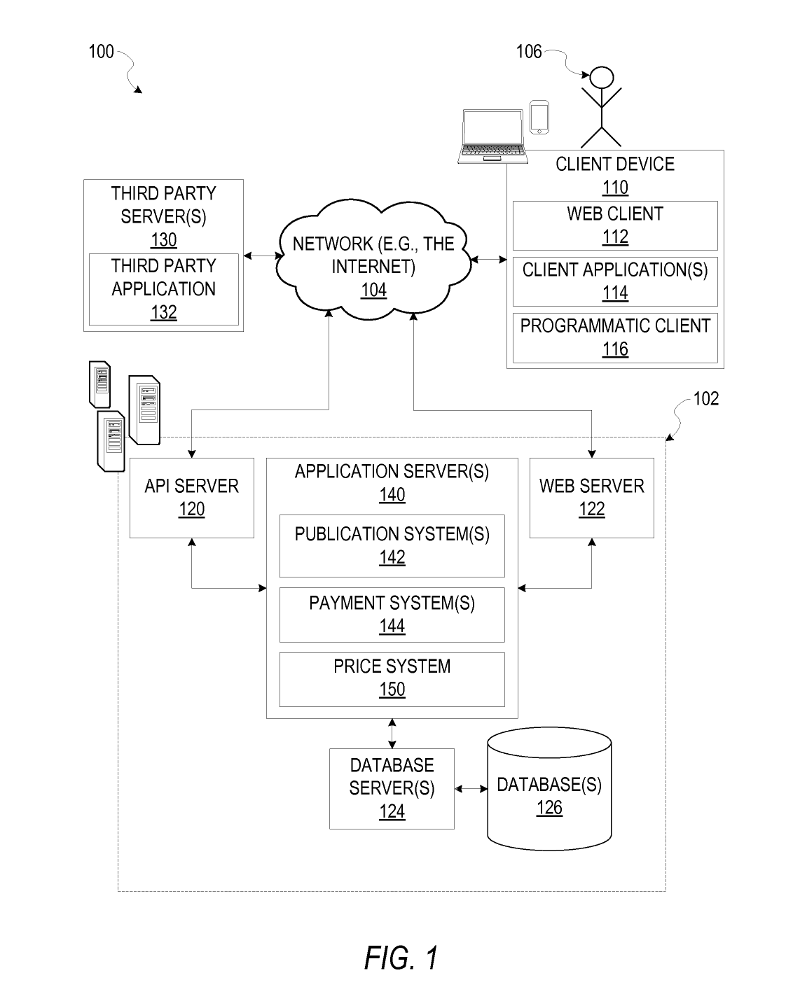

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The price system 150 may provide functionality operable to perform various price matching functions. For example, the price system 150 may receive a request from a client device 110 to perform a price match for an item. In some example embodiments, the price system 150 will identify a comparable item available for sale. The price system 150 may reference an SKU number of an item, a product number of an item, an image or description of the item. In doing so, the price system 150 may negotiate with one or more sellers that list the comparable item for sale. For example, the price system 150 may send out offers to each of the one or more sellers to see if they are willing to list the comparable item for a discounted price. As part of the negotiation process, the one or more sellers may response with to the offer with a promise to list the comparable item for the discounted price or with a certain advantage (e.g., lower shipping cost, providing loyalty points, providing warranty, and the like). The price system 150 may also receive preferences from the seller of the comparable item. Once the comparable item is identified, the price system 150 generates a message that is sent to the client device 110. In some example embodiments, the price system 150 may communicate with the publication systems 142 (e.g., accessing item listings) and payment system 144. In an alternative embodiment, the price system 150 may be a part of the publication system 142. The price system 150 may also communicate with the third party servers 130.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and price system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

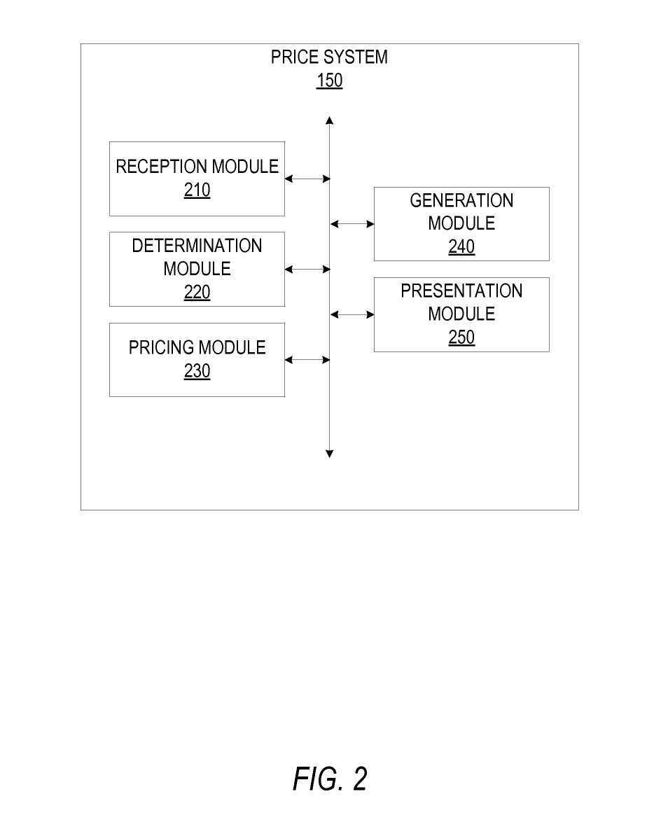

FIG. 2 is a block diagram illustrating components of the price system 150, according to some example embodiments. The price system 150 is shown as including a reception module 210, a determination module 220, a pricing module 230, a generation module 240, and a presentation module 250, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive, from a client device (e.g., client device 110) of a user, a message that identifies a first item listing of a first item. In some instances, the message is sent over a messaging service hosted by a messaging server. Moreover, a client component of the messaging service may be installed on the client device as a client application 114. The message that identifies the first item listing may include a link to the first item listing. Also, in some instances, the first item listing may be published by a third party application 132 executing on a third party server 130. An item listing may include a description of an item as well as a price of an item.

In further embodiments, if the link is broken or the first item listing is not from a trusted or legitimate market, the reception module 210 is to discard the message. This ensures that the price system 150 will not abused with data from an untrusted source.

In various example embodiments, the determination module 220 is configured to determine a price of a first item from the first item listing identified in the message. In doing so, the determination module 220 may access the item listing using the link from the message in order to locate the price of the first item from the first item listing.

In various example embodiments, the pricing module 230 is configured to identify a second item listing of a second item that is priced lower than the price of the first item. The second item listing may be published by a publisher that is distinct from a publisher of the first item listing. In some instances, the pricing module 230 is further to compare item characteristics of the first item with item characteristics of the second item, and to determine that the item characteristics of the first item match with the item characteristics of the second item. This ensures that the first and second items are comparable items, and that the user would be satisfied with purchasing the second item at a lower price than a price of the first item. In some instances, since the second item may be originally priced higher than the first item, the pricing module 230 is further to send a request to a seller of the second item to decrease the price of the second item. In various example embodiments, the pricing module 230 is further to receive pricing rules from the seller of the second item. Also, the pricing module 230 is further to identify the second item listing based on the received pricing rules. For instance, the pricing module 230 may be further configured to decrease the price of the second item based on the received pricing rules. In various example embodiments, the pricing module 230 is further to add the second item to a shopping cart associated with the user.

In further embodiments, the pricing module 230 is to identify multiple items that match with the first item. In other words, the pricing module 230 is to identify one or more items that are each comparable with the first item. Accordingly, the pricing module 230 is further to select a subset of items from the multiple items. Each item from the selected subset of items may offer a specific advantage. For instance, an item from the selected subset of items may be priced lower than the price of the first item. As another example, an item selected from the selected subset of items may offer free shipping. Further, an item selected from the selected subset of items may offer expedited shipping or faster shipping than a seller of the first item.

In various example embodiments, the generation module 240 is configured to generate a message that identifies the second item listing of the second item. As part of generating the message, the generation module 240 is further configured to generate an indication that the second item is priced lower than the first item. The generation module 240 is also to indicate an advantage that the second item has over the first item (e.g., free shipping, expedited shipping, loyalty points, and the like). Also, in some instances, the generation module 240 is further to use the messaging service to generate the message. Therefore, the generation module 240 is further to create an account with the messaging service.

In various example embodiments, the presentation module 250 is configured to cause display of the message that identifies the second item listing on the client device of the user. In order to accomplish this, presentation module 250 uses the messaging service to cause display of the message. In some instances, the message is publicly displayed. Therefore, the presentation module 250 is further to cause display of the message that identifies the second item listing to a plurality of users.

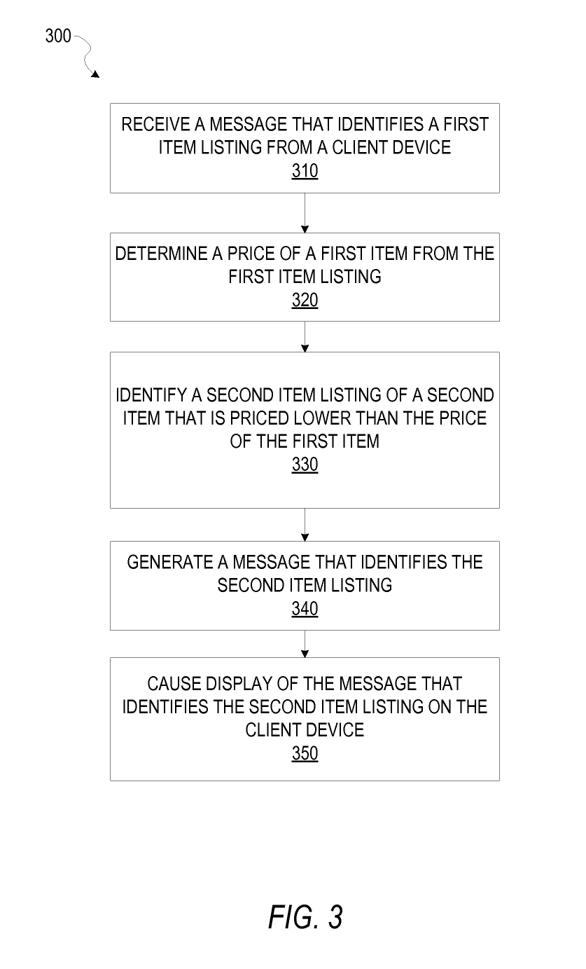

FIG. 3-6 are flowcharts illustrating operations of the price system 150 in performing a method 300 of generating a message that identifies a second item listing, according to some example embodiments. As shown in FIG. 3, the method 300 includes operations 310, 320, 330, 340, and 350.

At operation 310, the reception module 210 receives a message that identifies a first item listing from a client device. The first item listing may be a listing for a first item. Further, the item listing may include a price of the first item and a description of the first item. In some cases, the first item listing is published by a third party application executing on a third party server. For example, the first item listing may be published as part of a third party marketplace that is hosted by the third party server. Further, the third party server is distinct from the application servers 140 that host the price system 150. The third party marketplace may provide a plurality of item listings that are available for sale, which the client device may access using the network 104. A user, while browsing the third party marketplace, may discover the first item as an item of interest. However, the user may not be completely satisfied with the price of the item. As a result, the user sends the message that identifies the first item listing to the price system in order to search for a better deal.

The reception module 210 may receive the message over a messaging service. The messaging service may be a SMS (Short Message Service), a MMS (Multimedia Messaging Service), an Instant Messaging Service, a Social Network Messaging Service and the like. Further, the user may have an account registered with the messaging service. Therefore, the user may send the message from the client device to the reception module 210 through the account.

In some instances, the message includes a tag, such as a hashtag. Also, the reception module 210 is further to receive the message based on the tag included in the message. For instance, the messaging service may allow the message to be accessed by any users of the messaging service. As a result, the reception module 210 may be further configured to search for the message using the hashtag included in the message.

At operation 320, the determination module 220 determines a price of the first item from the first item listing. As stated before, the message may include a link to the first item listing published by the third party server. The client device, having browsed the first item listing from the third party marketplace, may include the link in the message in order to identify the first item listing to the price system 150. The determination module 220 activates the link in order to access the first item listing from the third party marketplace. Once the first item listing has been accessed, the determination module 220 extracts the price of the first item from the first item listing. In some instances, the price of the first item listing may already be included in the message received by the reception module 210. Therefore, the determination module 220 reads the price of the first item listing from the message. In various example embodiments, the price of the first item includes costs associated with shipping the first item to the user.

At operation 330, the pricing module 230 identifies a second item listing of a second item that is priced lower than the price of the first item. The second item listing may be published by a publication server that is distinct from the third party server that published the first item listing. For example, the second item listing may be published by the publication systems 142 shown in FIG. 1 whereas the first item listing is published by the third party server 130. Moreover, the second item listing may be part of a marketplace hosted by the application servers 140. Also, the second item listed in the second item listing may be similar or comparable with the first item, as further explained below.

At operation 340, the generation module 240 generates a message that identifies the second item listing. The generated message may also include an indication that the second item is priced lower than the first item. For example, the message may include text which shows an amount of savings associated with purchasing the second item instead of the first item. As another example, the message may include a symbol to indicate that the second item is priced lower than the first item. For example, the message may include a star to indicate that the price of the second item is lower than the price of the first item. In some embodiments, the generation module 240 may also modify a color of the message to indicate that the second item is priced lower than the first item. In some embodiments, the generation module 240 is further to include a link to the second item listing in the generated message. The link may be used by the user to conveniently view the second item listing that is priced lower than the first item.

In some instances, the generation module 240 uses the messaging service to generate the message. The user may have sent the message that identifies the first item listing by using the messaging service. Therefore, the generation module 240 may send a reply to the user by using the same messaging service. An account with the messaging service may be used by the generation module 240 to generate the message. For instance, the generation module 240 will access the messaging service using the account with the messaging service in order to compose the reply message.

At operation 350, the presentation module 250 causes display of the message that identifies the second item listing on the client device. In some instances, the presentation module 250 uses the account with the messaging service to cause display of the message. For example, the presentation module 250 sends the message through the account with the messaging service. In doing so, the messaging server of the messaging service may be involved in transmitting the message to the client device. Thereafter, the message gets displayed on the client device. In various example embodiments, the message that identifies the second item listing is also displayed by the presentation module 250 to a plurality of users. The plurality of users may also be users of the messaging service. In this way, the message that identifies the second item listing is available to the general public and is accessible through the messaging service. Therefore, the presentation module 250 causes display of the message that identifies the second item listings on respective client devices of the plurality of users.

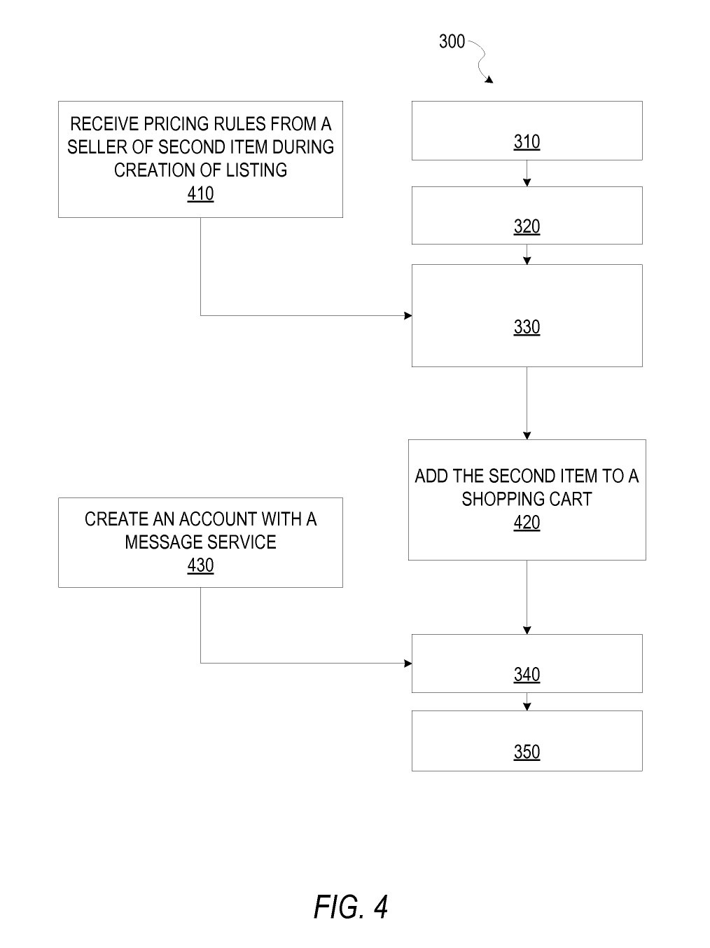

As shown in FIG. 4, the method 300 also includes operations 410, 420, and 430. Operation 410 may be performed prior to operation 330. Operation 420 may be performed after operation 330, but prior to operation 340. Also, operation 430 may be performed prior to operation 340.

At operation 410, the pricing module 230 receives pricing rules from a seller of the second item during creation of the second item listing. The pricing module 230 may send a request for the pricing rules from the seller when the seller creates the item listing. The received pricing rules indicate certain preferences or criteria of the seller with regards to pricing the second item. For example, the pricing rules may indicate certain advantages that the seller is willing to offer in the sale of the second item (e.g., a minimum price, free shipping, loyalty points, and the like). In this regard, the seller may permit or allow the pricing module 230 to automatically lower the price of the second item in order to have it beat a competitor's price. The seller may also indicate a minimum price at which the seller is willing to sell the second item. Moreover, the pricing module 230 is further to identify the second item based on the received pricing rules.

At operation 420, the pricing module 230 adds the second item to a shopping cart. The shopping cart may be associated with the marketplace where the second item is listed. Moreover, the shopping cart is also associated with an account that the user has with the marketplace. Therefore, once the second item has been added to the shopping cart, the user may navigate over to the shopping cart in order to purchase the second item from the second seller within the marketplace. This may also save some effort on behalf of the user of navigating to the second item listing and adding the second item to the shopping cart.

At operation 430, the generation module 240 creates an account with the messaging service. As discussed earlier at operation 340, the generation module 240 uses the messaging service to generate the message. Also, the messaging service may only allow communications to be between registered accounts. Therefore, the generation module 240 generates the account with the messaging service in order to use the messaging service to communicate with the user.

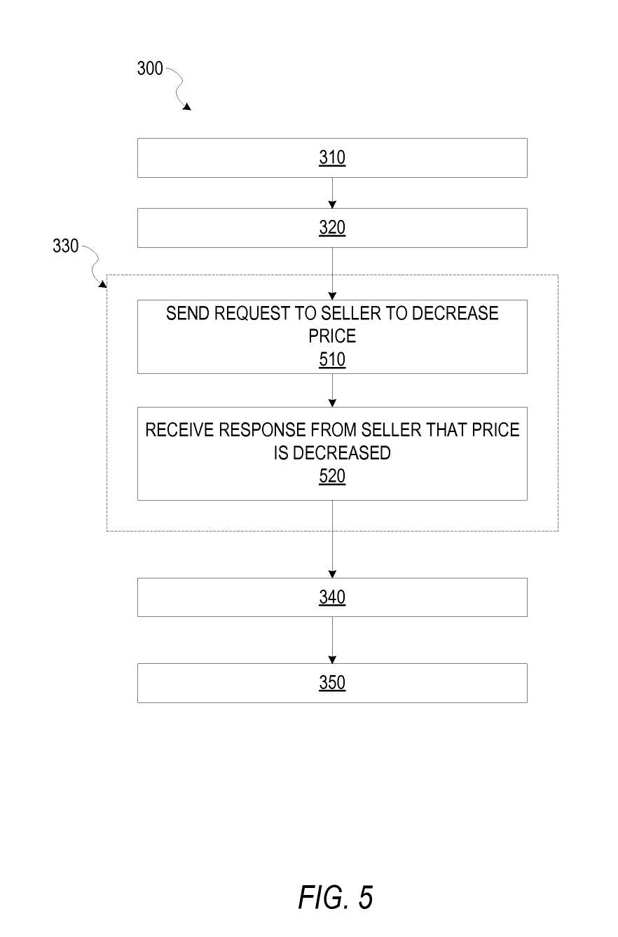

As shown in FIG. 5, the method 300 also includes operations 510 and 520. The operations 510 and 520 may be performed as part of operation 330.

At operation 510, the pricing module 230 sends a request to the seller to decrease the price of the second item. The seller may not have permitted or allowed the pricing module 230 to automatically lower the price of the second item. Therefore, the pricing module 230 sends the request in order to receive permission from the seller to lower the price of the second item. In doing so, the pricing module 230 may send the request through the messaging service. The request may also include statistics of other sellers that have sold items similar to the second item. This statistics may serve as a reference point for the seller, and to encourage the seller to lower the price of the second item.

At operation 520, the pricing module 230 receives a response from the seller that the price of the second item is decreased. In other words, the seller may decide to lower the price of the second item upon receipt of the request. Also, the seller may send a message back to the pricing module 230 through the messaging service.

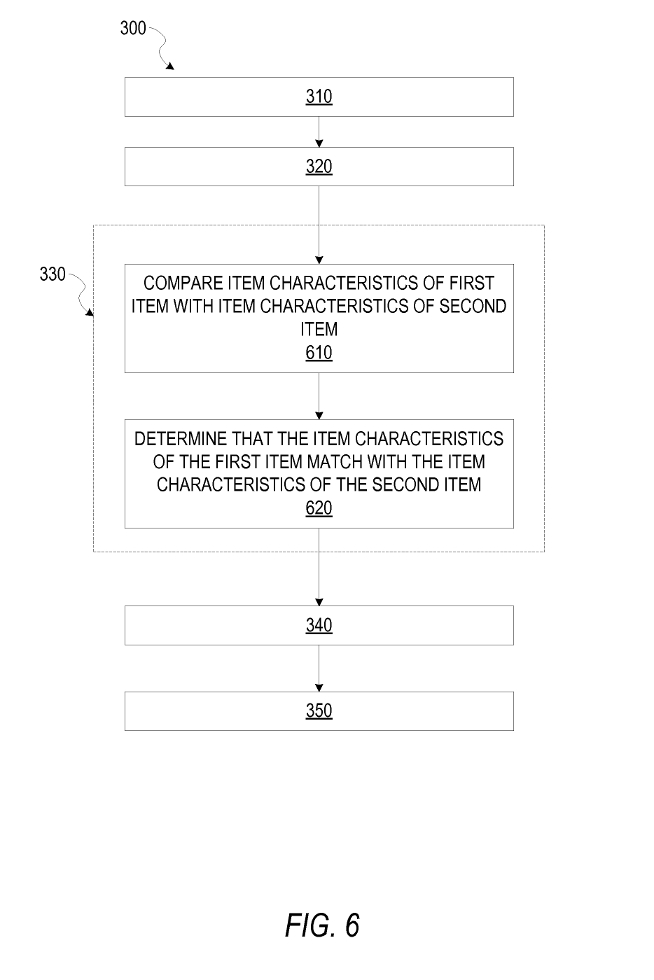

As shown in FIG. 6, the method 300 also includes operations 610 and 620. The operations 610 and 620 may be performed as part of operation 330.

At operation 610, the pricing module 230 compares item characteristics of the first item with item characteristics of the second item. Item characteristics include a color of the item, brand of the item, style of the item, purpose of the item, size of the item, an identifier of the item, and the like.

At operation 620, the pricing module 230 determines that the item characteristics of the first item match with the item characteristics of the second item. In the case of items that are identical, most if not all of the item characteristics will match. However, for items that are similar, a certain number of the item characteristics will match. In either case, the pricing module 230 may be further to determine that a threshold number of the item characteristics of the first item match with the item characteristics of the second item. In some cases, the first item may have an identification number (e.g., ISBN number, SKU number, and the like) which serves as a unique identifier for the first item. Also, the second item may have an identification number that matches with the identification number for the first item.

In further embodiments, the pricing module 230 identifies several critical item characteristics of the first item. For example, a size of the first item or a color of the item may be considered a critical item characteristic. Moreover, the pricing module 230 searches for items that match with the critical item characteristics of the first item. In other words, as long as the searched for items match with the critical item characteristics, then they are considered to be similar items with the first item. For example, as long as the size of the searched for item and the color of the searched for item match with the first item, then the searched for item is considered to be matched with the threshold number of item characteristics of the first item.

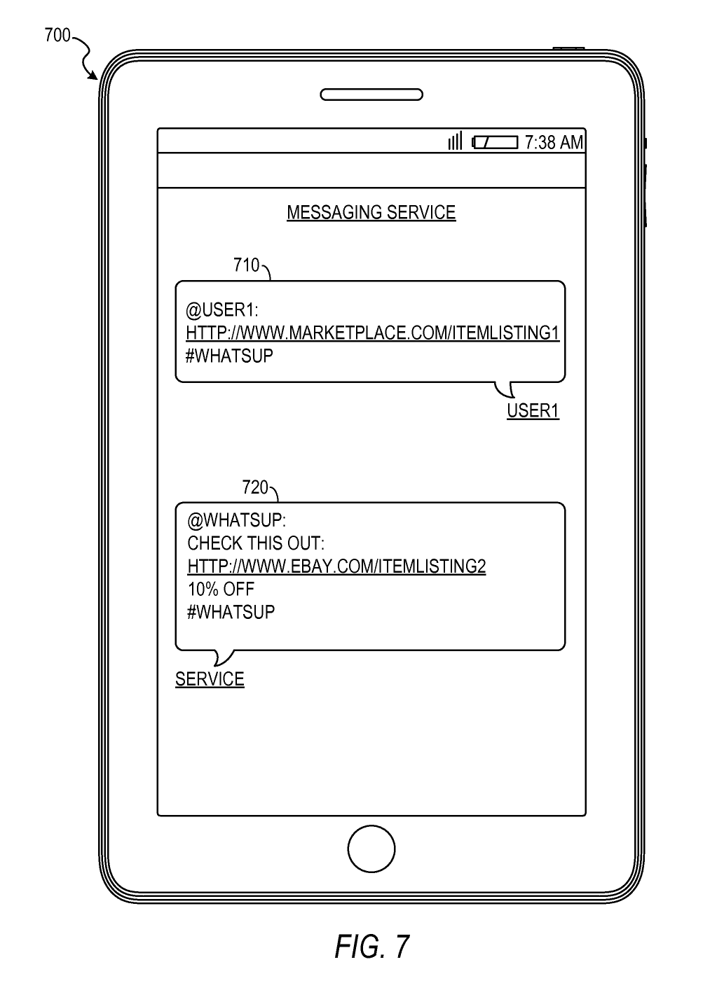

FIG. 7 is an example user interface 700 that depicts a conversation between a user and the pricing system, according to some example embodiments. The user interface 700 may be displayed on a client device operated by the user. As shown in FIG. 7, the user interface 700 includes a first message 710 and a second message 720. The first message 710 is sent from the client device to the pricing system, and is received by the pricing system at operation 310 of FIG. 3. The first message also identifies a first item listing. As stated earlier, the user may send the message to the price system to see if there another item similar to the item in the first item listing and that is available for a lower price. After performing a search and identifying a second item, the price system sends the second message 720 back to the client device, which is performed at operation 350 of FIG. 3. The second message includes a link to an item listing for the second item.

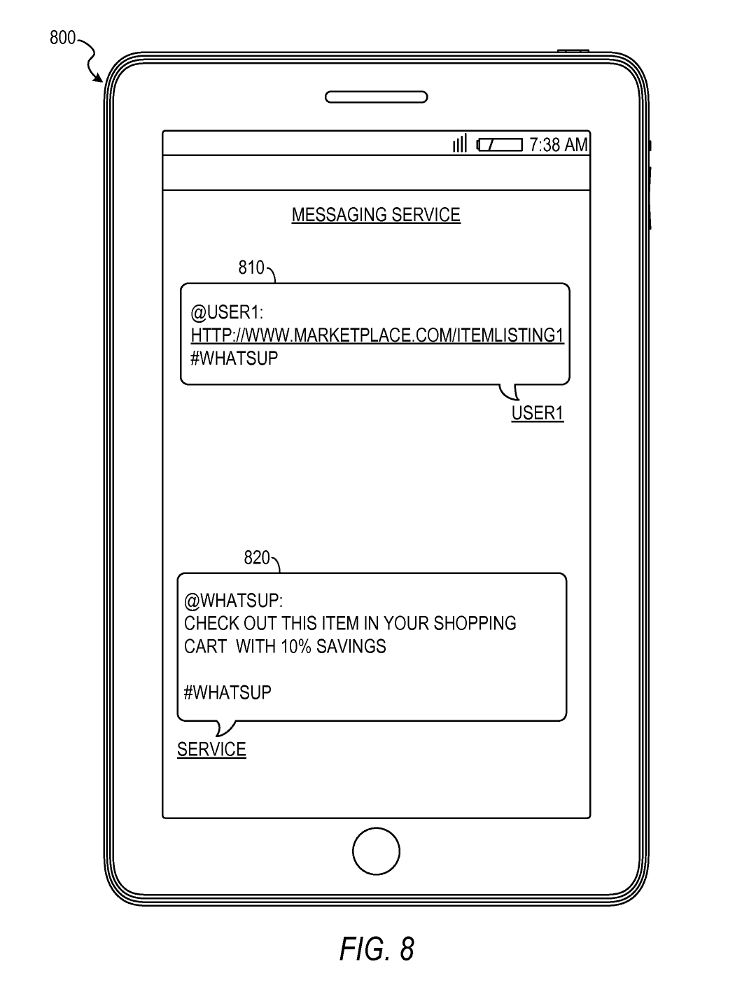

FIG. 8 is an example user interface 800 that depicts a conversation between a user and the pricing system, according to some example embodiments. The user interface 800 may be displayed on the client device operated by the user. Also, similar to FIG. 7, the user interface 800 in FIG. 8 includes a first message 810 and a second message 820. The first message 810 is sent from the client device to the pricing system, and is received by the pricing system at operation 310 of FIG. 3. The second message 820 is sent from the pricing system back to the client device, which is performed at operation 350 of FIG. 3. The second message 820 indicates to the user that an item similar to the first item is available for a lower price. The second message also indicates that the second item has been added to a shopping cart of the user, which was performed at operation 420 of FIG. 4.

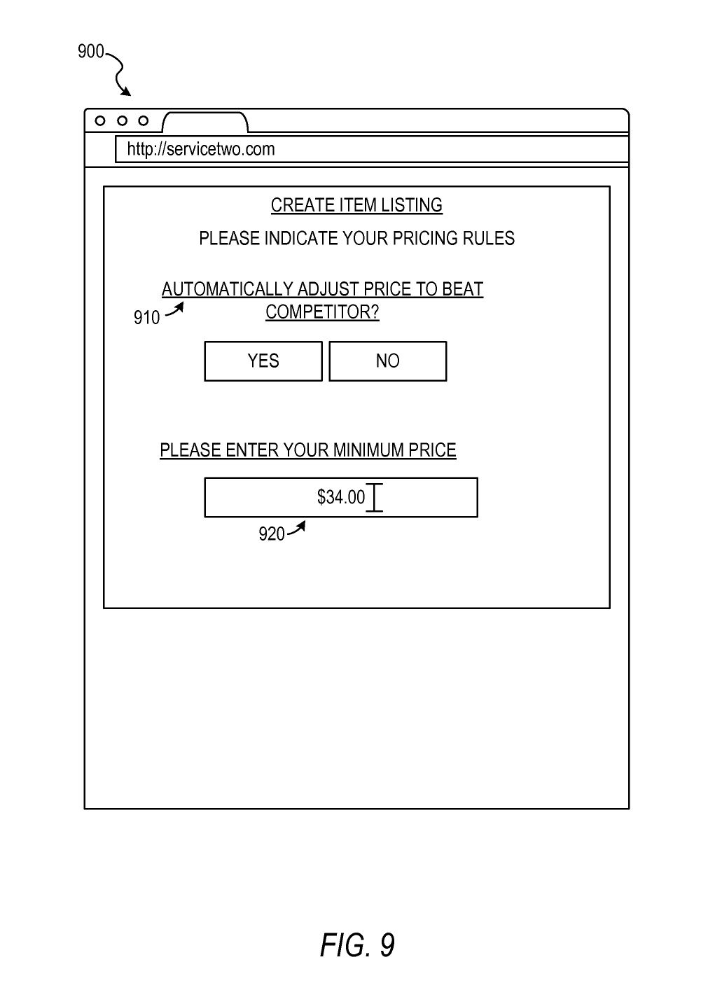

FIG. 9 is an example user interface 900 that depicts an item listing creation page, according to some example embodiments. The item listing creation page also includes a request 910. As shown, the request 910 prompts the user to see if there is an agreement to automatically adjust the price of the item in the event that there is a competitor that lists the same or similar item for a cheaper price. The user interface 900 also includes a field 920 where the user can enter in a minimum price. The minimum price represents a lowest price at which the user is willing to sell the item. The pricing module 230 may use this information to lower the price of the item.

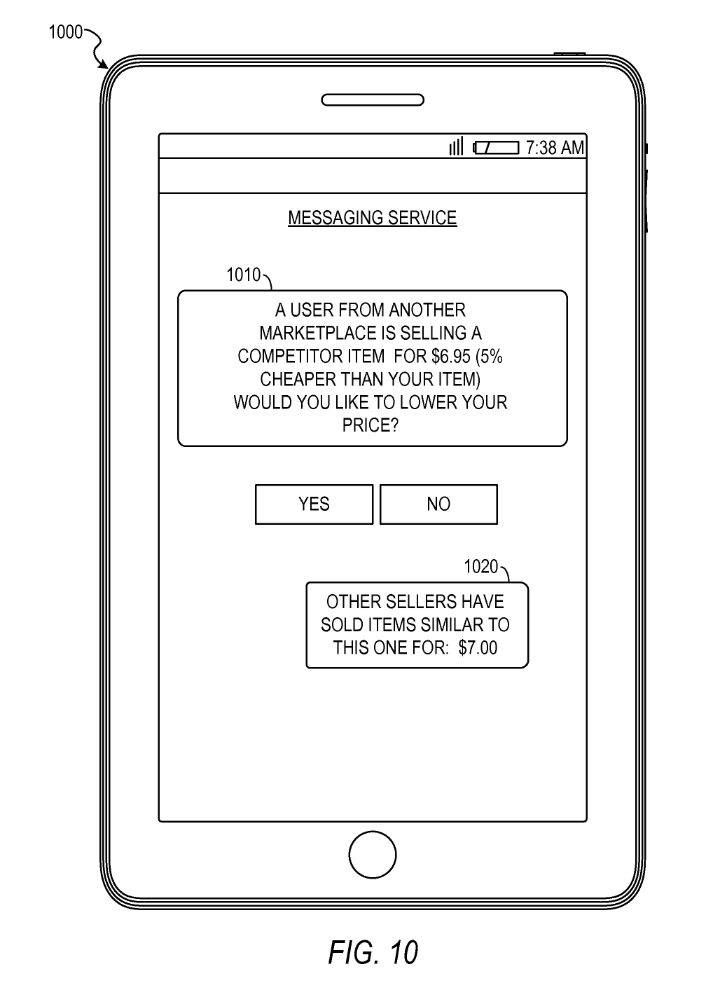

FIG. 10 is an example user interface 1000 that depicts a message that requests a seller to lower a price of an item, according to some example embodiments. The user interface 1000 may be displayed on a client device that is operated by the seller of the item. Also, the user interface 1000 includes a message 1010 from the price system requesting the seller to lower the price of the item. The pricing system may be prompted to send this request because seller did not previously allow the price system to automatically lower the price of the item. The user interface 1000 also includes a further message 1020 that displays additional information about the sale of similar items. The additional information serves as a reference point for the seller in order to allow the seller to make an informed decision about lowering the price of the item.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 2-6 are implemented in some embodiments in the context of a machine and associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

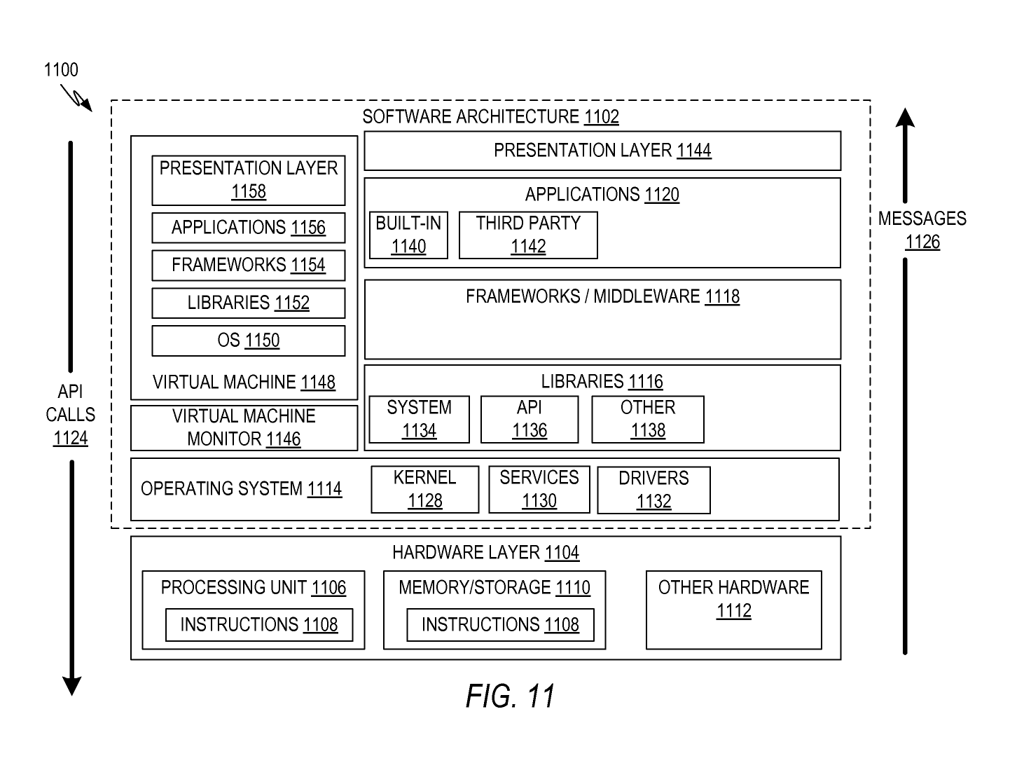

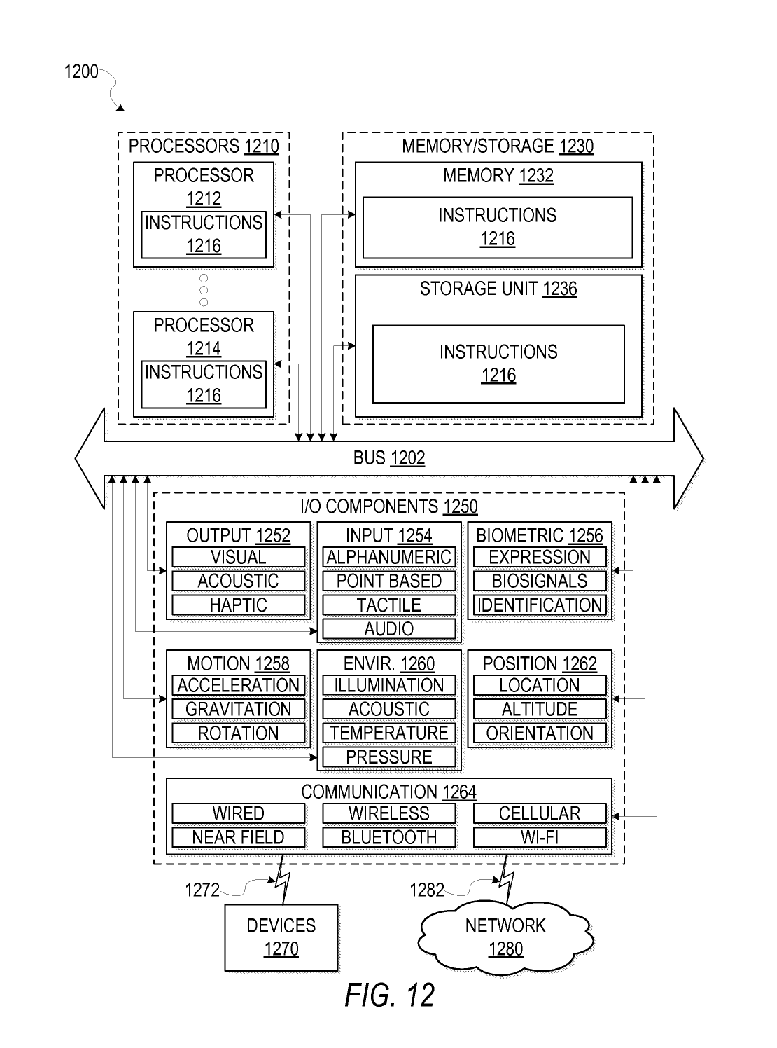

FIG. 11 is a block diagram 1100 illustrating a representative software architecture 1102, which may be used in conjunction with various hardware architectures herein described. FIG. 11 is merely a non-limiting example of a software architecture and it will be appreciated that many other architectures may be implemented to facilitate the functionality described herein. The software architecture 1102 may be executing on hardware such as machine 1200 of FIG. 12 that includes, among other things, processors 1210, memory 1230, and I/O components 1250. A representative hardware layer 1104 is illustrated and can represent, for example, the machine 1200 of FIG. 12. The representative hardware layer 1104 comprises one or more processing units 1106 having associated executable instructions 1108. Executable instructions 1108 represent the executable instructions of the software architecture 1102, including implementation of the methods, modules and so forth of FIGS. 2-6. Hardware layer 1104 also includes memory and/or storage modules 1110, which also have executable instructions 1108. Hardware layer 1104 may also comprise other hardware as indicated by 1112 which represents any other hardware of the hardware layer 1104, such as the other hardware illustrated as part of machine 1200.

In the example architecture of FIG. 11, the software 1102 may be conceptualized as a stack of layers where each layer provides particular functionality. For example, the software 1102 may include layers such as an operating system 1114, libraries 1116, frameworks/middleware 1118, applications 1120 and presentation layer 1144. Operationally, the applications 1120 and/or other components within the layers may invoke application programming interface (API) calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system 1134 libraries (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1140 and/or third party applications 1142. Examples of representative built-in applications 1140 may include, but are not limited to, a contacts application, a browser application, a book reader application, a location application, a media application, a messaging application, and/or a game application. Third party applications 1142 may include any of the built in applications as well as a broad assortment of other applications. In a specific example, the third party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1142 may invoke the API calls 1124 provided by the mobile operating system such as operating system 1114 to facilitate functionality described herein.

The applications 1120 may utilize built in operating system functions (e.g., kernel 1128, services 1130 and/or drivers 1132), libraries (e.g., system 1134, APIs 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware machine (such as the machine of FIG. 12, for example). A virtual machine is hosted by a host operating system (operating system 1114) and typically, although not always, has a virtual machine monitor 1146, which manages the operation of the virtual machine as well as the interface with the host operating system (i.e., operating system 1114). A software architecture executes within the virtual machine such as an operating system 1150, libraries 1152, frameworks/middleware 1154, applications 1156 and/or presentation layer 1158. These layers of software architecture executing within the virtual machine 1148 can be the same as corresponding layers previously described or may be different.

### Example Machine Architecture and Machine-Readable Medium

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example the instructions may cause the machine to execute the flow diagrams of FIGS. 3-6. Additionally, or alternatively, the instructions may implement the modules of FIG. 2, and so forth. The instructions transform the general, non-programmed machine into a particular machine programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory 1230, and I/O components 1250, which may be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1212 and processor 1214 that may execute instructions 1216. The term “processor” is intended to include multi-core processor that may comprise two or more independent processors (sometimes referred to as “cores”) that may execute instructions contemporaneously. Although FIG. 12 shows multiple processors, the machine 1200 may include a single processor with a single core, a single processor with multiple cores (e.g., a multi-core process), multiple processors with a single core, multiple processors with multiples cores, or any combination thereof.

The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of processors 1210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1250 may include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion and the grouping is in no way limiting. In various example embodiments, the I/O components 1250 may include output components 1252 and input components 1254. The output components 1252 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environmental components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1262 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via coupling 1282 and coupling 1272 respectively. For example, the communication components 1264 may include a network interface component or other suitable device to interface with the network 1280. In further examples, communication components 1264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a Universal Serial Bus (USB)).

Moreover, the communication components 1264 may detect identifiers or include components operable to detect identifiers. For example, the communication components 1264 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1280 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network and the coupling 1282 may be a Code Division Multiple Access (CDMA) connection, a Global System for Mobile communications (GSM) connection, or other type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 may be transmitted or received over the network 1280 using a transmission medium via a network interface device (e.g., a network interface component included in the communication components 1264) and utilizing any one of a number of well-known transfer protocols (e.g., hypertext transfer protocol (HTTP)). Similarly, the instructions 1216 may be transmitted or received using a transmission medium via the coupling 1272 (e.g., a peer-to-peer coupling) to devices 1270. The term “transmission medium” shall be taken to include any intangible medium that is capable of storing, encoding, or carrying instructions 1216 for execution by the machine 1200, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a client device of a user, a message that identifies a first item listing of a first item;
determining a price of the first item from the first item listing identified in the message;
identifying a second item listing of a second item that is priced lower than the price of the first item and that is comparable to the first item;
generating, using one or more processors, a message that identifies the second item listing of the second item; and
causing display of the message that identifies the second item listing on the client device of the user.

2. The method of claim 1, further comprising:
creating an account with a messaging service hosted by a messaging server.

3. The method of claim 2, wherein the generating the message that identifies the second item listing is performed using the account with the messaging service.

4. The method of claim 1, wherein the first item listing is published by a first web server and the second item listing is published by a second web server different from the first web server.

5. The method of claim 1, further comprising:
receiving pricing rules from a seller of the second item, and wherein the identifying the second item listing of the second item includes decreasing a price of the second item based on the received pricing rules.

6. The method of claim 5, wherein the pricing rules are received from the seller during creation of the second item listing.

7. The method of claim 1, wherein the identifying the second item listing of the second item includes:
sending a request to the seller of the second item to decrease the price of the second item; and
receiving a response from the seller of the second item that the price of the second item is decreased.

8. The method of claim 1, wherein the price of the first item includes costs of shipping the first item to the user.

9. The method of claim 1, wherein the identifying the second item listing of the second item includes:
comparing item characteristics of the first item with item characteristics of the second item; and
determining that the item characteristics of the first item match with the item characteristics of the second item.

10. The method of claim 1, further comprising:
adding the second item to a shopping cart associated with an account of the user with a marketplace.

11. The method of claim 1, wherein the generated the message includes generating an indication that the second item is priced lower than the first item.

12. The method of claim 1, further comprising:
causing display of the second message that identifies the second item listing to a plurality of users.

13. The method of claim 1, wherein the receiving of the message is based on a tag that is included in the message.

14. A system comprising:
a reception module configured to receive, from a client device of a user, a message that identifies a first item listing of a first item;
a determination module configured to determine a price of the first item from the first item listing identified in the message;
a pricing module configured to identify a second item listing of a second item that is priced lower than the price of the first item and that is comparable to the first item;
a generation module configured to generate a message that identifies the second item listing of the second item; and
a presentation module configured to cause display of the message that identifies the second item listing on the client device of the user.

15. The system of claim 14, wherein the generation module is further configured to create an account with a messaging service hosted by a messaging server.

16. The system of claim 15, wherein the generation module is further configured to generate the message using the account with the messaging service.

17. The system of claim 14, wherein the first item listing is published by a first web server and the second item listing is published by a second web server different from the first web server.

18. The system of claim 14, wherein the pricing module is further configured to receive pricing rules from a seller of the second item, and identify the second item listing based on the received pricing rules.

19. The system of claim 14, wherein the pricing module is further configured to send a request to the seller of the second item to decrease the price of the second item, and receive a response from the seller of the second item that the price of the second item is decreased.

20. A non-transitory machine-readable medium storing instructions that, when executed by one or more processors of a machine, cause the machine to perform operations comprising:
receiving, from a client device of a user, a message that identifies a first item listing of a first item;
determining a price of the first item from the first item listing identified in the message;
identifying a second item listing of a second item that is priced lower than the price of the first item and that is comparable to the first item;
generating a message that identifies the second item listing of the second item; and
causing display of the message that identifies the second item listing on the client device of the user.
